(19) United States
(12) Patent Application Publication
(10) Pub. No.: US 2019/0072081 A1
(43) Pub. Date: Mar. 7, 2019

(54) Airborne wind turbine

(71) Applicant: Kitewinder, Bordeaux (FR)

(72) Inventor: Olivier Normand, Toulouse (FR)

(73) Assignee: Kitewinder, Bordeaux (FR)

(21) Appl. No.: 16/083,706

(22) PCT Filed: Mar. 9, 2017
(86) PCT No.: PCT/FR2017/050526

§ 371 Date: Sep. 10, 2018

(30) Foreign Application Priority Data
Mar. 10, 2016 (FR) 16 51990
Nov. 18, 2016 (FR) 16 61221

(51) Int. Cl. F03D 15/20; F03D 9/25; F03D 7/02

(52) U.S. Cl. CPC F03D 15/20; F05B 2240/921; F03D 7/0248; F03D 9/25

(57) ABSTRACT

An airborne device comprising a wind turbine with an axis of rotation, an airborne structure configured to support the wind turbine, a lift system configured to keep the airborne structure in flight, at least one belt for transmitting a rotational movement of the wind turbine to a ground station, said belt being guided by at least one ground-based return pulley, wherein each ground-based return pulley is rigidly secured to a pivoting shaft, is positioned in a guide plane perpendicular to the pivoting shaft and is configured to guide the belt, wherein the axis of rotation of the wind turbine and the guide plane of each ground-based return pulley form an angle of less than 60°.

### RELATED APPLICATIONS

This application is a national phase of International Application No. PCT/FR2017/050526 filed on Mar. 9, 2017, which claims priority to French Applications No. 16 51990 and 16 61221, filed on Mar. 10, 2016 and Nov. 18, 2016, respectively, the entireties of all of which are incorporated herein by reference.

### FIELD AND BACKGROUND OF THE INVENTION

The present application relates to an airborne wind turbine.

WO2013/151678 discloses a wind turbine that is hung from a wing.

According to one embodiment presented in this document, the wind turbine comprises four propellers that are each connected by a link to an anti-rotation device which is itself connected by a single link to the ground. According to this configuration, the four propellers move in a circle the axis of which passes through the anti-rotation device.

According to one feature of this document, the rotational movement is converted into electrical energy on the ground. To that end, the rotational movement of the propellers is transmitted to the ground by means of a belt. Whatever the variant, the belt is supported at the propellers by a circle that forms a pulley the guiding plane (corresponding to the plane of the pulley) of which is perpendicular to the axis of rotation of the propellers.

This type of airborne wind turbine is not entirely satisfactory since the tension in the belt is difficult to control owing to the fact that the anti-rotation device is also connected by a link to the ground.

According to another drawback, since the guiding plane of the pulley supporting the belt is perpendicular to the axis of rotation of the propellers, the system for transmitting the rotational movement to the ground tends to disrupt the operation of the wind turbine or vice versa.

The present invention aims to remedy the drawbacks of the prior art.

### BRIEF DESCRIPTION OF THE INVENTION

To that end, the invention relates to an airborne device comprising a wind turbine having an axis of rotation, an airborne structure configured to support the wind turbine, a lifting system configured to keep aloft the airborne structure, at least one belt to transmit a movement of rotation of the wind turbine to a ground station, said belt being guided by at least one return-to-ground pulley, each return-to-ground pulley being supported by a pivoting shaft, positioned in a guiding plane perpendicular to the pivoting shaft and configured to guide the belt. According to the invention, the axis of rotation of the wind turbine and the guiding plane of each return-to-ground pulley form an angle of less than 60°.

This configuration serves to limit disruption, induced by the system for transmitting the rotational movement to the ground, to the operation of the wind turbine, or vice versa.

### BRIEF DESCRIPTION OF THE DRAWINGS

Other features and advantages will emerge from the following description of the invention, provided solely by way of example and with reference to the appended drawings, in which:

FIG. 1 is a side view of an airborne device connected to the ground by a belt which illustrates a first variant of the invention,

FIG. 2 is a side view of the airborne structure of the airborne device shown in FIG. 1,

FIG. 3 is a perspective view of the airborne structure shown in FIG. 1,

FIG. 4 is a view from above of the airborne structure according to an embodiment of the invention,

FIG. 5 is an end-on view of a system for guiding the strands of a belt according to an embodiment of the invention,

FIG. 6 is a perspective view from the rear of a ground station according to an embodiment of the invention,

FIG. 7 is a perspective view from the front of a ground station according to an embodiment of the invention,

FIGS. 8A and 8B are detail views showing a system for blocking the pulley, respectively in the unblocked and blocked state,

FIGS. 9A and 9B are detail views showing a clutch between a geared motor and the pulley, respectively in the disengaged and engaged state,

FIG. 10 is a side view of an airborne device connected to the ground by a belt which illustrates a second variant of the invention,

FIG. 11 is an end-on view of a blade support of the airborne device shown in FIG. 10,

FIG. 12 is a perspective view of an airborne structure of the airborne device shown in FIG. 10,

FIG. 13 is a perspective view of a ground station, showing another embodiment,

FIG. 14 is a perspective view of the ground station shown in FIG. 13, without part of the cover,

FIG. 15 is a perspective view of an airborne structure, showing another variant, and

FIG. 16 is a side view of a return-to-ground pulley of the airborne structure shown in FIG. 15.

### DETAILED DESCRIPTION OF THE INVENTION

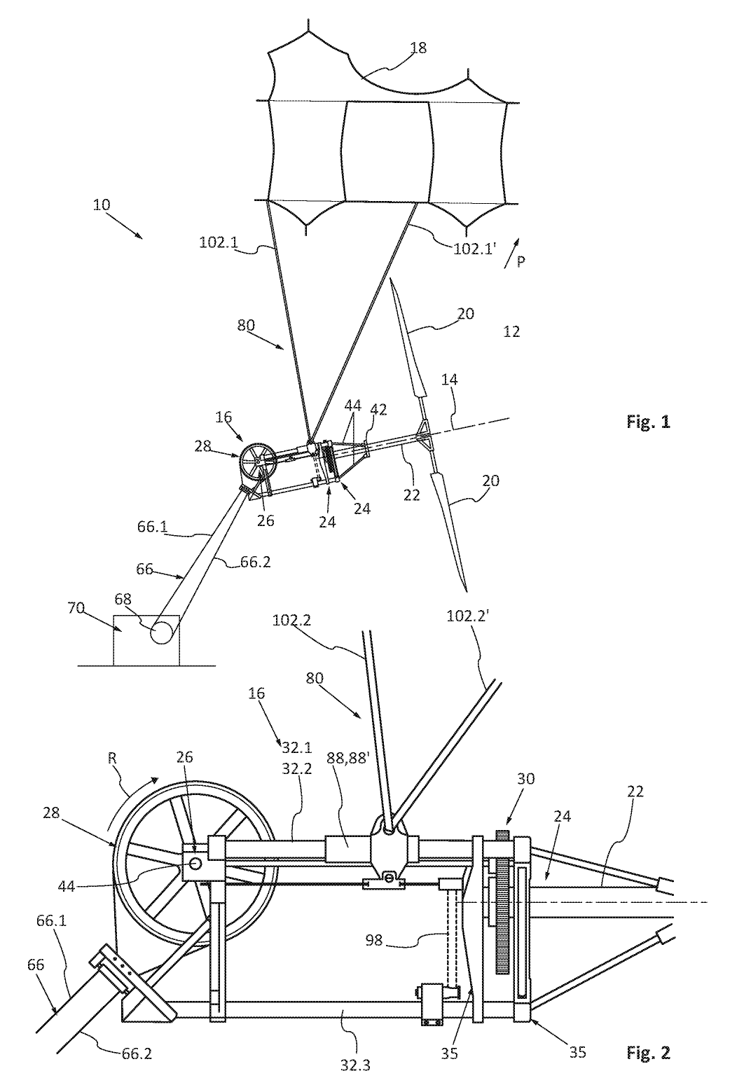

FIGS. 1 to 5 show a first variant of an airborne device 10 comprising a wind turbine 12 having an axis of rotation 14, an airborne structure 16 that supports the wind turbine 12, and a lifting system 18 that keeps aloft the airborne structure 16.

According to one embodiment shown in FIG. 1, the lifting system 18 is a wing.

According to one embodiment, the wind turbine 12 comprises blades 20 that are connected to a rotating shaft 22 which embodies the axis of rotation of the wind turbine 12.

In operation, the wind orients the airborne device 10 in a direction hereinafter referred to as the lifting direction P. Moreover, the lifting direction P forms, with a horizontal direction, a lifting angle which depends in particular on the lifting system 18.

In the case of a wind turbine having blades connected to a rotating shaft 22, the axis of rotation 14 of the wind turbine and the lifting direction P are coplanar.

The airborne structure 16 comprises a first pivoting connection 24 that supports the rotating shaft 22, a second pivoting connection 26 that supports a first pulley 28 and also a system 30 for transmitting the rotational movement between the rotating shaft 22 and the pulley 28.

According to one embodiment, the airborne structure 16 comprises a chassis formed of three longerons 32.1 to 32.3 which are mutually parallel, are oriented in a longitudinal direction and are arranged at the apexes of an isosceles triangle. Thus, the chassis comprises two upper longerons 32.1 and 32.2 that are arranged in an upper plane, and one lower longeron 32.3. These longerons 32.1 to 32.3 may be connected to one another by reinforcements 34 which are arranged in transverse planes (perpendicular to the longitudinal direction) and which each connect the longerons in pairs.

For the remainder of the description, the front of the chassis corresponds to the region located close to the wind turbine in the longitudinal direction and the rear of the chassis corresponds to a region located away from the wind turbine.

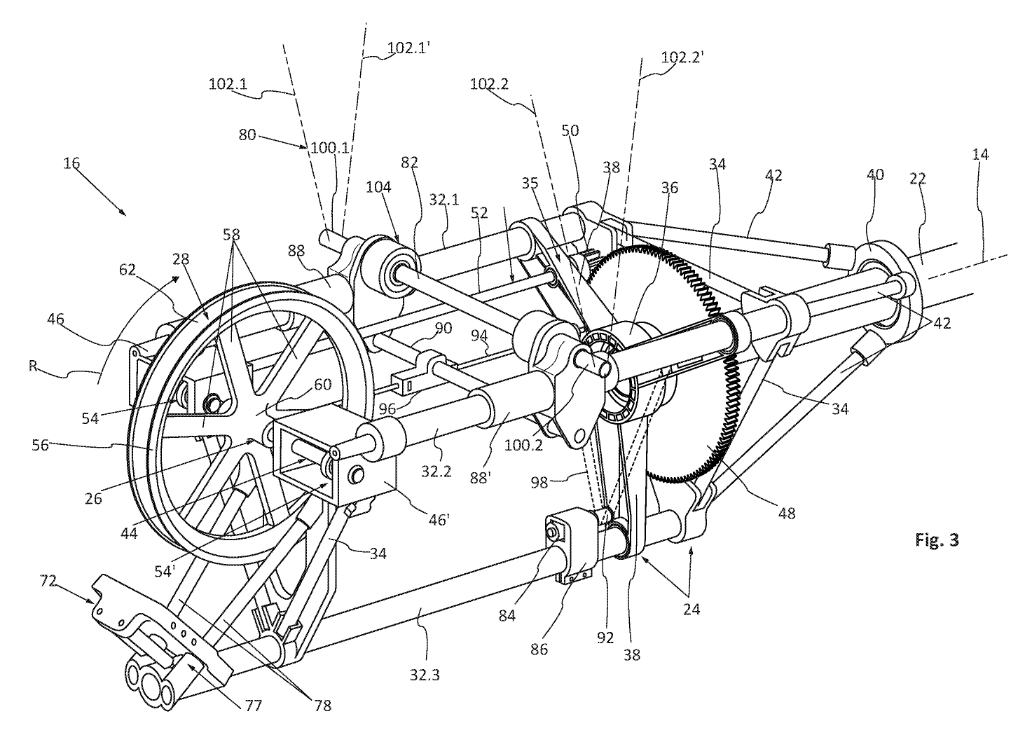

According to one embodiment shown in FIG. 3, the first pivoting connection 24 comprises:
at least one support 35 that comprises a hub 36 supporting one end of the rotating shaft 22 and three spokes 38 that connect the hub 36 to the longerons 32.1 to 32.3,
a guide ring 40 connected by reinforcements 42 to the longerons 32.1 and 32.3.

Preferably, there are provided two supports 35 arranged in two transverse planes.

In order to improve the stability of the guiding, the guide ring 40 is as far as possible from the hub 36. Thus, the reinforcements 42 are inclined and their ends connected to the guide ring 40 are oriented toward the second end of the rotating shaft 22 supporting the blades of the wind turbine.

According to one embodiment, the second pivoting connection 26 comprises a pivoting shaft 44 on which is mounted the first pulley 28, the ends of the pivoting shaft 44 are mounted so as to pivot in devises 46, 46′ provided at each of the rear ends of the upper longerons 32.1 and 32.2.

Advantageously, the system 30 for transmitting the rotational movement comprises a gearing means. According to one embodiment, the transmission system 30 comprises:
a first, large-diameter gear wheel 48 arranged between the two supports 35 and secured to the rotating shaft 22,
a second, small-diameter gear wheel 50 which meshes with the first gear wheel 48 and is secured to a transmission shaft 52,
an angle transmission 54 interposed between the transmission shaft 52 and the pivoting shaft 44 positioned at one of the devises 46.

The transmission shaft 52 is supported in rotation by the support(s) 35 at a first end and by the clevis 46 at the other end.

According to one embodiment shown in FIGS. 3 and 4, the transmission system 30 comprises:
a first, large-diameter gear wheel 48 secured to the rotating shaft 22,
a second, small-diameter gear wheel 50 which meshes with the first gear wheel 48 and is secured to a first transmission shaft 52,
a first angle transmission 54 interposed between the first transmission shaft 52 and the pivoting shaft 44 positioned at a first clevis 46,
a third gear wheel 50′, whose diameter is identical to that of the second gear wheel 50, which meshes with the first gear wheel 48 and is secured to a second transmission shaft 52′ that is symmetric with the first transmission shaft 52 with respect to the axis of the rotating shaft 22,
a second angle transmission 54′ interposed between the second transmission shaft 52′ and the pivoting shaft 44 positioned at a second clevis 46′.

The first pulley 28 is arranged in a plane referred to as the guiding plane, perpendicular to the axis of the pivoting shaft 44. According to one embodiment, the first pulley 28 comprises a peripheral crown 56 connected by spokes 58 to a central portion 60 secured to the pivoting shaft 44. The peripheral crown 56 comprises, at its outer surface, a channel 62 configured to guide a belt 66 (shown in FIGS. 1, 2 and 5) that is slung between the first pulley 28 and a second pulley 68 located on the ground. According to one configuration, the second pulley 68 is coupled to a system 70 for transforming mechanical energy (rotational movement) into electrical energy, such as a generator. The second pulley 68 and the system 70 form a ground station.

The first and second pulleys 28, 68, together with the belt 66, form a mechanism for transmitting rotational movement between the airborne device and the ground.

The first and second pulleys 28, 68 are preferably arranged in a same guiding plane. As a variant, depending on the wind direction, it is possible for the guiding plane of the first pulley 28 to not be coplanar with the guiding plane of the second pulley 68.

According to one feature of the invention, the guiding plane of the first pulley 28 is not perpendicular to the axis of rotation of the wind turbine 12, which corresponds to the axis of the rotating shaft 22. The axis of rotation of the wind turbine forms, with the guiding plane, an angle of less than 60°. This configuration serves to limit disruption, induced by the system for transmitting a rotational movement to the ground, to the operation of the wind turbine.

Preferably, the axis of rotation of the wind turbine 12 is contained in the guiding plane of the first pulley 28. This configuration serves to serves to eliminate almost all disruption, induced by the system for transmitting a rotational movement to the ground, to the operation of the wind turbine.

According to one preferred configuration, the rotating shaft 22 is perpendicular to the pivoting shaft 44 and, in operation, the orientation of the pivoting shaft 44 is essentially horizontal.

Advantageously, the airborne structure 16 comprises a system 72 for guiding the belt 66, which serves to take up slack in the strands of the belt 66 in order that the belt 66 does not come loose and does not leave the channel 62 of the first pulley 28.

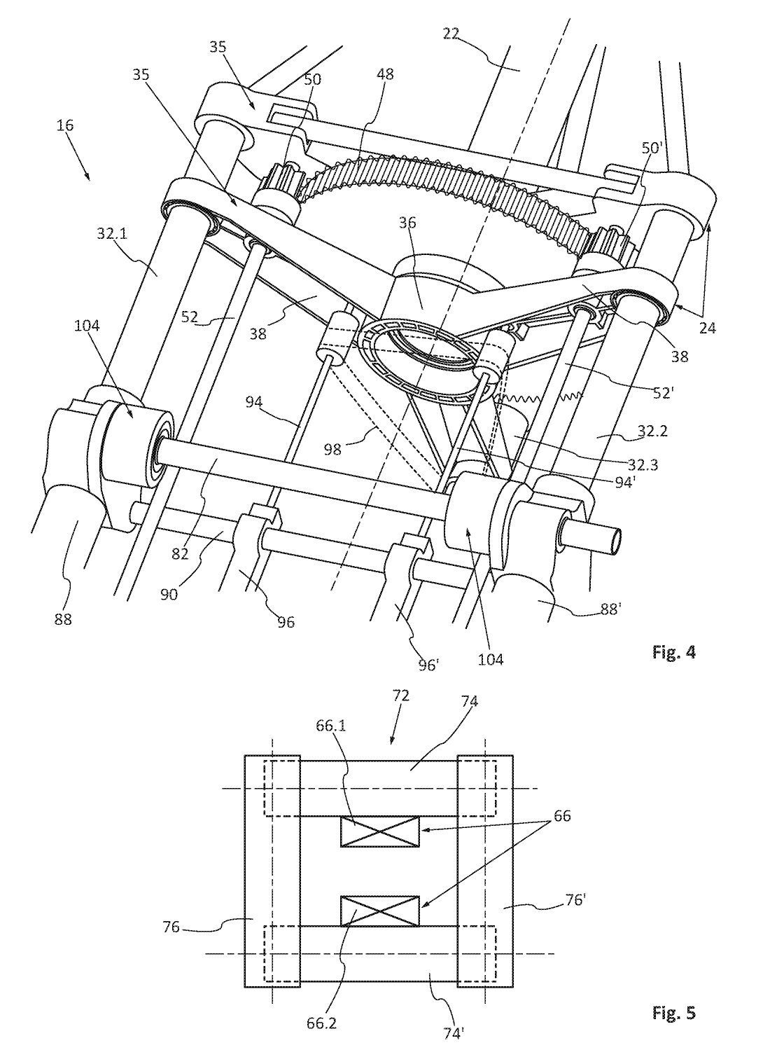

Preferably, the guiding system 72 comprises at least a first pair of rollers 74, 74′ which are parallel to the axis of the pivoting shaft 44, have a small gap between them, and between which both strands 66.1 and 66.2 of the belt 66 pass. According to an embodiment shown in FIG. 5, the guiding system 72 comprises a second pair of rollers 76, 76′ which are parallel to one another, perpendicular to the rollers 74, 74′, have a small gap between them, and between which both strands 66.1 and 66.2 pass.

The two pairs of rollers 74, 74′, 76, 76′ are secured to a support 77 (shown in FIG. 3) which is positioned at the rear end of the lower longeron 32.3 and is connected by reinforcements 78 to the upper longerons 32.1 and 32.2.

The airborne structure 16 comprises a connection 80 for connecting it to the lifting system 18.

According to one embodiment, the connection 80 comprises at least one connection element such as a rod 82 which is able to move with respect to the airborne structure 16 in the longitudinal direction, an inclination measuring system 84 configured for measuring the inclination of the airborne structure about an axis perpendicular to the longitudinal direction, a control unit 86 configured to move the rod 82 in the longitudinal direction depending on the inclination measured by the inclination measuring system in order that the measured value of the inclination remain within a given range on either side of the horizontal. This configuration serves to keep the rotating shaft 44 approximately horizontal.

According to one embodiment, the rod 82 is secured to 2 sliders 88, 88′ that are configured to slide along the upper longerons 32.1 and 32.2.

The two sliders 88, 88′ are connected by a crosspiece 90 that is perpendicular to the longitudinal direction.

The inclination measuring system 84 may be an inclinometer or any other sensor.

The control unit 86 is in the form of an electric motor that is secured to the lower longeron 32.3, with an output gear wheel 92 oriented in the longitudinal direction.

There is provided a system for transmitting the rotational movement of the output gear wheel 92 into a translational movement of the crosspiece 90. This transmission system comprises at least one threaded rod 94 extending in the longitudinal direction, at least one nut 96 mounted on the threaded rod 94 and secured to the crosspiece 90, a belt or a chain 98 connecting the output gear wheel 92 and the threaded rod 94. According to one preferred embodiment with which it is possible to balance forces, the transmission system comprises two threaded rods 94, 94′ and two nuts 96, 96′ arranged symmetrically with respect to the axis of the rotating shaft 22.

Of course, the invention is not restricted to this embodiment for converting the rotational movement of the control unit 86 into a translational movement along the longitudinal direction of the rod 82.

Preferably, the rod 82 oriented in a transverse direction (perpendicular to the longitudinal direction) comprises two ends 100.1, 100.2 which are each connected by at least one line 102.1 and 102.2 to the lifting system 18. Advantageously, each end 100.1 and 100.2 of the rod 82 is connected, by two lines 102.1, 102.1′, 102.2, 102.2′, to the lifting system 18, as shown in FIG. 3.

According to another feature of the invention, the rod 82 is connected to the sliders 88, 88′ by a pivoting connection which integrates a mechanism 104 for limiting the angular acceleration about the axis of the rod 82. This solution serves to limit the angular movements of the rod 82, which improves the stability of the airborne structure 16. Thus, according to this configuration, forward and backward tipping movements about a transverse axis are braked.

According to one embodiment, this mechanism 104 for limiting the angular acceleration about the axis of the rod 82 comprises a rotary damper for each slider 88, 88′.

According to another variant, the lines 102.1, 102.1′, 102.2, 102.2′ are connected directly to the sliders 88, 88′, as shown in FIG. 2.

The belt 66 comprises a first strand 66.1 positioned over the first pulley 28 and a second strand 66.2 positioned under the first pulley 28.

According to another feature of the invention, the airborne structure and the wind turbine are oriented and configured such that the direction of rotation R of the first pulley 28 tautens the first strand 66.1. Since the second strand 66.2, located below the first strand 66.1, is less taut than the first strand 66.1, its weight tends to move it away from the first strand 66.1, which further separates the two strands 66.1 and 66.2.

FIGS. 6 and 7 show a ground station 110.

This ground station 110 comprises a chassis 112 that is anchored to the ground, a support 114 to which the second pulley 68 is connected by means of a pivoting connection having an essentially horizontal axis 116.

Advantageously, the support 114 is connected to the chassis 112 by means of a pivoting connection having an essentially vertical axis of rotation 118. This configuration allows the support 114 to pivot freely about the essentially vertical axis of rotation 118 such that the second pulley 68 is automatically ideally oriented in dependence on the wind direction.

The second pulley 68 is coupled to a generator 120 that serves to convert the rotational movement of the second pulley 68 into electrical energy. This generator 120 is connected to the support 114.

According to one feature, the ground station 110 comprises a mechanism 122 for immobilizing the belt 66 with respect to the second pulley 68, this mechanism being configured to adopt an unblocked state, shown in FIG. 8A, in which the mechanism 112 does not interfere with the belt 66 and does not immobilize it with respect to the second pulley 68, and a blocked state, shown in FIG. 8B, in which the mechanism 122 interferes with the belt 66 and immobilizes it with respect to the second pulley 68. Thus, in the unblocked state, the running movement of the belt 66 is converted into rotational movement of the second pulley 68 and then into electrical energy by means of the generator 120. In the blocked state, with the belt 66 being immobilized with respect to the second pulley 68, the rotational movement of the second pulley 68 is converted into a movement of winding or unwinding the two strands of the belt 66 around the second pulley 68, in the manner of a winch.

According to one embodiment, the second pulley 68 comprises a channel 124 which receives the belt 66 and which is extended by two flanks 126 and 126′. The mechanism 122 comprises a bar 128 that is mobile in a direction parallel to the essentially horizontal axis of rotation 116 of the second pulley 68. This bar 128 is able to move between a retracted position, shown in FIG. 8A and corresponding to the unblocked state in which it does not connect the two flanks 126 and 126′, and an extended position, shown in FIG. 8B and corresponding to the blocked state in which it connects the two flanks 126, 126′ such that the belt 66 is immobilized between the channel 124 and the bar 128 and such that the two strands of the belt 66 are driven in rotation at the same generator of the second pulley so as to bring about either winding of the belt 66 around the second pulley 68 and return to the ground of the airborne structure when the mechanism 122 is in the blocked state and the second pulley 68 rotates in a first direction, or alternatively unwinding of the belt 66 and deployment of the airborne structure when the mechanism 122 is in the blocked state and the second pulley 68 rotates in a second direction counter to the first direction. When the belt is no longer wound around the second pulley 68, the mechanism 122 can switch to the unblocked state. In these cases, the running movement of the belt 66 is converted into rotational movement of the second pulley 68 and then into electrical energy by means of the generator 120.

The mechanism 122 comprises an actuator for controlling the movement of the bar 128 between the retracted position and the extended position.

In order to drive the second pulley 68 in rotation, the ground station 110 comprises a motor 130 connected via a clutch 132 to the second pulley 68.

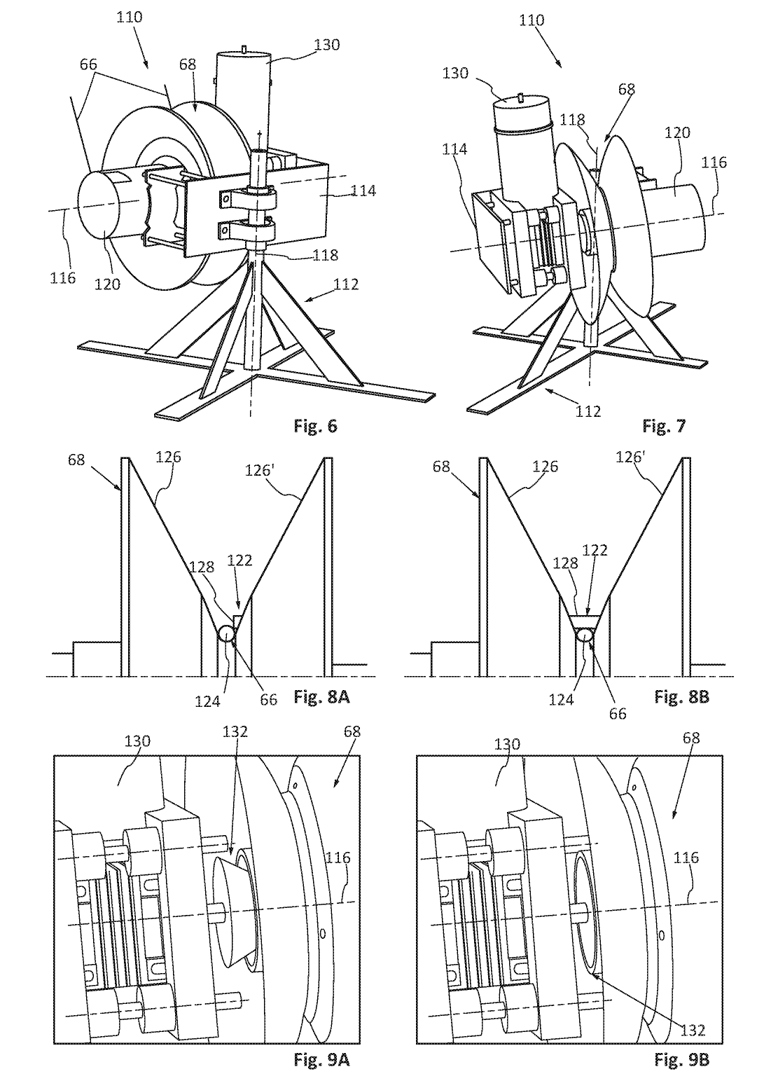

This clutch 132 is configured so as to adopt a disengaged state, shown in FIG. 9A, in which the rotational movement of the motor 130 is not transmitted to the second pulley 68, and an engaged state, shown in FIG. 9B, in which the rotational movement of the motor 130 is transmitted to the second pulley 68.

According to one embodiment, the clutch 132 is of the conical type.

The motor 130 serves to control the rotational movement of the second pulley 68 and to impose a rotational movement in a first direction which causes winding of the belt 66 around the second pulley 68, or a rotational movement in a second direction, counter to the first, which causes unwinding of the belt 66 around the second pulley 68.

The clutch 132 serves to brake the rotation of the second pulley 68, in particular when switching between the unblocked state and the blocked state.

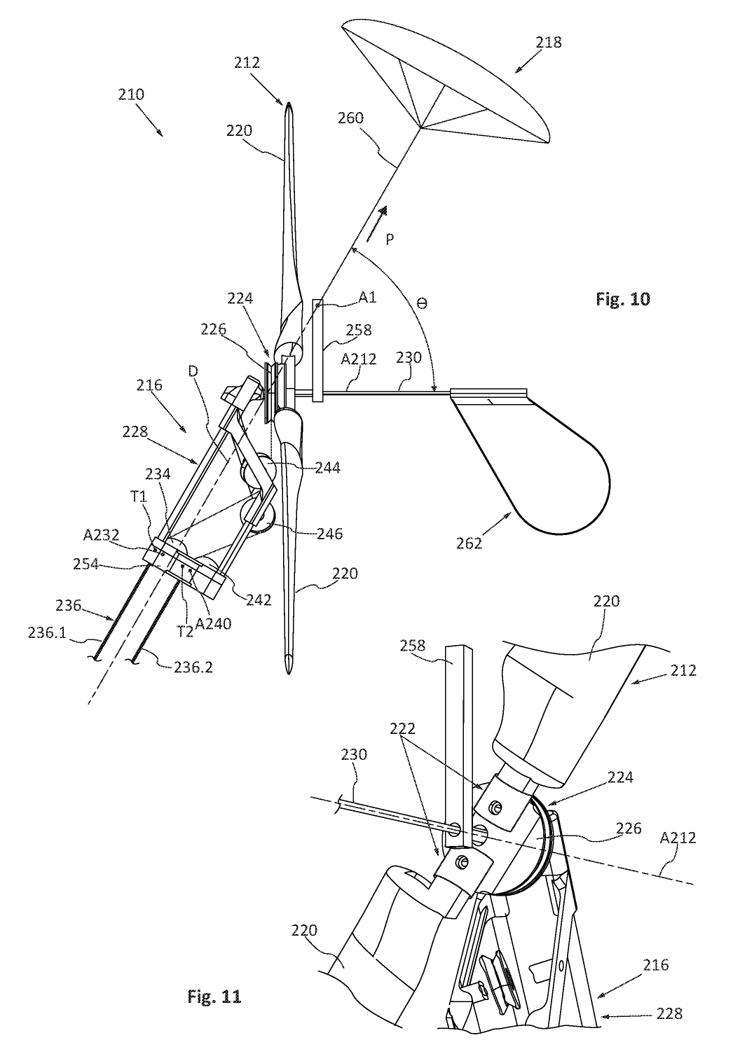

FIGS. 10 to 12 show a second variant of an airborne device 210 comprising a wind turbine 212 having an axis of rotation A212, an airborne structure 216 that supports the wind turbine 212, and a lifting system 218 that keeps aloft the airborne structure 216.

The wind turbine 212 comprises multiple blades 220 connected by a connection 222 to a support 224 that pivots about the axis of rotation of the wind turbine A212.

According to one embodiment, the pivoting support 224 is a main pulley 226 arranged in a plane perpendicular to the axis of rotation of the wind turbine A212.

According to one embodiment, the connection 222 between each blade 220 and the pivoting support 224 is removable. By way of example, the removable connection 222 comprises:
for each blade 220, a sheath which is secured to the pivoting support 224, extends in a direction perpendicular to the axis of rotation of the wind turbine A212 and is configured such that an end of the blade can be slotted in,
for each sheath, a blocking system configured to keep the end of the blade slotted in the sheath.

The airborne structure 216 comprises a chassis 228 and a fixed shaft 230 which defines the axis of rotation of the wind turbine A212 and on which the pivoting support 224 is mounted in rotation. The fixed shaft 230 comprises stops for immobilizing in translation the pivoting support 224 in a direction parallel to the axis of rotation of the wind turbine A212.

The airborne structure comprises a first pivoting shaft supported by the chassis 228, which defines a first pivot axis A232 and at least one first return pulley 234 that is configured to guide a belt 236 serving to transmit the rotational movement of the wind turbine 212 to a ground station 238 and is mounted so as to be able to pivot about the first pivot axis A232.

The first return pulley 234 is arranged in a first guiding plane perpendicular to the first pivot axis A232.

The airborne structure comprises a second pivoting shaft supported by the chassis 228, which defines a second pivot axis A240 and at least one second return pulley 242 configured for guiding the belt 236.

The second return pulley 242 is arranged in a second guiding plane perpendicular to the second pivot axis A240.

For preference, the first and second guiding planes are coplanar.

Advantageously, as for the first variant, each guiding plane of the return pulleys 234 and 242 is not perpendicular to the axis of rotation of the wind turbine A212. The axis of rotation of the wind turbine forms, with each guiding plane, an angle of less than 60°.

Preferably, the axis of rotation of the wind turbine A212 is contained in the guiding planes of the return pulleys 234 and 242, which are coplanar.

According to one preferred configuration, the axis of rotation of the wind turbine A212 is perpendicular to the pivot axes A232 and A240 of the return pulleys 234 and 242.

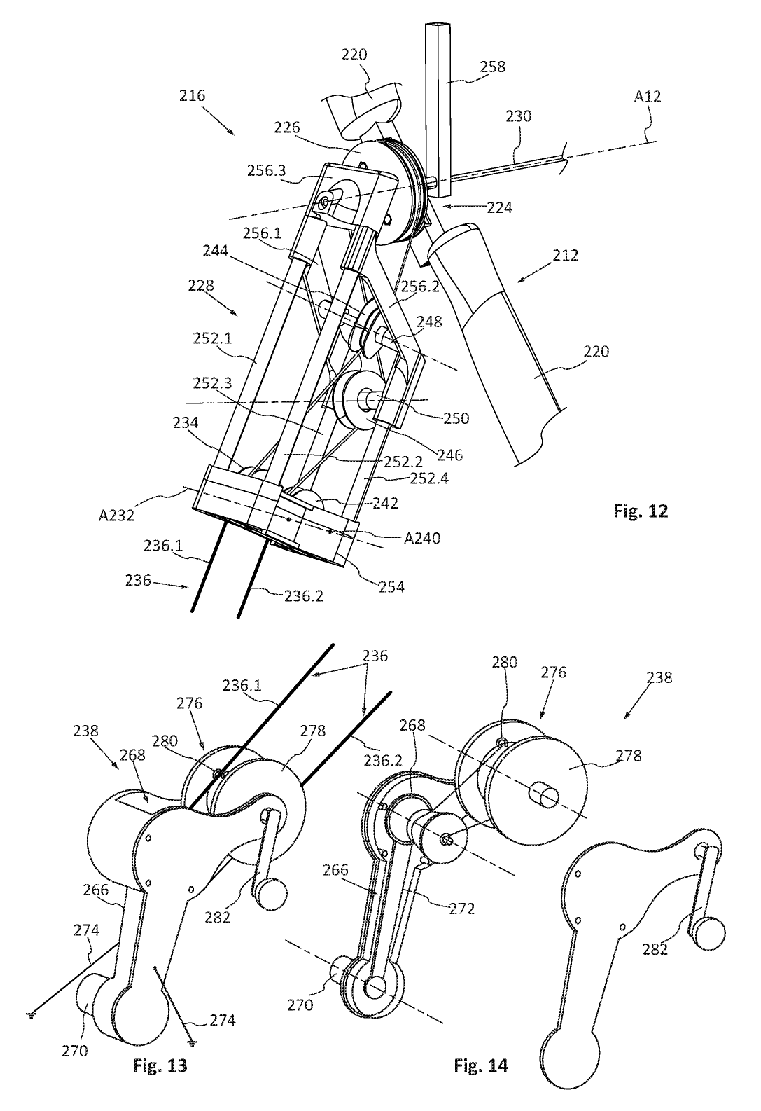

According to one embodiment, shown in particular in FIG. 12, the airborne structure comprises a third return pulley 244 and a fourth return pulley 246, respectively between the first return pulley 234 and the main pulley 226 and between the second return pulley 242 and the main pulley 226.

The third and fourth return pulleys 244 and 246 are mounted so as to be able to pivot on third and fourth pivoting shafts 248 and 250 that are secured to the chassis 228 and are positioned in third and fourth guiding planes so as to guide the belt 236 respectively between the main pulley 226 and the first return pulley 234 and between the main pulley 226 and the second return pulley 242. Thus, the third guiding plane is approximately tangential to the main pulley 226 and the first return pulley 234, and the fourth guiding plane is approximately tangential to the main pulley 226 and the second return pulley 242.

By way of non-limiting example, according to an embodiment shown in FIG. 12, the chassis 228 comprises four longerons 252.1 to 252.4 which are mutually parallel and are oriented approximately parallel to the lifting direction P during operation, and a frame 254 connecting the first ends of the longerons 252.1 to 252.4 and supporting the first and second pivoting shafts. The second ends of the longerons 252.1 and 252.3 are connected by a first crosspiece 256.1 and the second ends of the longerons 252.2 and 252.4 are connected by a second crosspiece 256.2, with the first and second crosspieces 256.1 and 256.2 supporting the third and fourth pivoting shafts 248 and 250. The longerons 252.1 and 252.2 are connected by a third crosspiece 256.3 that is approximately perpendicular to the longerons 252.1 and 252.2 and is parallel to the first and second pivot axes A232 and A240.

In operation, the belt 236 passes over the first return pulley 234, under the third return pulley 244, over the main pulley 226, under the fourth return pulley 246 and over the second return pulley 242.

Whatever the variant, the airborne structure 216 comprises at least one return-to-ground pulley for guiding the belt 66, 236 toward the ground, said belt 66, 236 comprising two strands 66.1/66.2; 236.1/236.2, each having a point of tangency T1, T2 with at least one return-to-ground pulley.

In the case of the variant shown in FIGS. 1 to 5, the airborne structure comprises a single return-to-ground pulley 28, the strands 66.1, 66.2 of the belt 66 being tangential to the same return-to-ground pulley 28 at two points of tangency T1, T2.

In the case of the variant shown in FIGS. 10 to 12, the airborne structure 216 comprises two return-to-ground pulleys 234, 242, the first return pulley 234 having a point of tangency T1 with the strand 236.1 and the second return pulley 242 having a point of tangency T2 with the strand 236.2.

According to one feature, the airborne structure 216 comprises, on a first side of the wind turbine 212, a point A1 for connection to the lifting system 218 and, on a second side of the wind turbine, the two points of tangency T1, T2. A bisector D between the straight lines A1T1 and A1T2 forms an angle, with the axis of rotation of the wind turbine A212, essentially equal to the lifting angle θ with a tolerance range of +/−20°. Preferably, the bisector D between the straight lines A1T1 and A1T2 forms an angle, with the axis of rotation of the wind turbine A212, essentially equal to the lifting angle θ.

Thus, in operation, the axis of rotation of the wind turbine A212 is essentially horizontal.

According to one configuration, the airborne structure 216 comprises a strut 258 which has a first end connected to the fixed shaft 230 on the first side of the pivoting support 224. The first connection point A1 is provided on the strut 258 and remote from the fixed shaft 230. Preferably, the strut 258 is perpendicular to the fixed shaft 230.

According to one embodiment, the fixed shaft 230 has a first end connected to the third crosspiece 256.3, equidistant from the longerons 252.1 and 252.2.

The lifting system 218 is connected by at least one line 260 to the second end of the strut 258. In operation, the straight line D, aligned with the line 260, is approximately parallel to the strands 236.1 and 236.2 and is positioned equidistant from said strands 236.1, 236.2.

According to another feature, the airborne structure 216 comprises a stabilizing system 262 for limiting the rotational movement about the axis of rotation of the wind turbine A212. According to one embodiment, the stabilizing system 262 comprises an essentially rigid planar stabilizing surface which extends in a plane containing the axis of rotation of the wind turbine A212 and which is connected to the second end of the fixed shaft 230. The stabilizing surface is parallel to the guiding planes of the first and second return pulleys 234 and 242, and it is oriented so as to be vertical and offset downward with respect to the fixed shaft 230 during operation.

FIGS. 13 and 14 show another variant of a ground station 238 which comprises a chassis 266 that supports a receiver pulley 268 which is configured to guide the belt 236, a generator 270 coupled to the receiver pulley 268 via a transmission system 272. Thus, the running of the belt 236 causes the receiver pulley 268 to rotate, which then rotates the generator 270 by virtue of the transmission system 272.

The generator 270 is configured to transform a rotational movement into electric current.

According to one configuration, the chassis 266 is in the form of a casing comprising two flanges which are parallel and between which are positioned the receiver pulley 268 and the transmission system 272.

The airborne device is connected to the ground station by the two strands 236.1 and 236.2 of the belt 236 which, respectively, connect the receiver pulley 268 and the first return pulley 234, and the receiver pulley 268 and the second return pulley 242.

No other link connects the airborne device and the ground or an element secured to the ground.

According to one configuration, the ground station 238 comprises a fastening system 274 for connecting it to the ground or to an element secured to the ground.

The ground station 238 comprises a system 276 for winding and unwinding the belt 236. In the fully unwound state, the airborne structure hangs below the lifting system, and in the fully wound state the airborne structure is next to the ground station.

The system 276 for winding and unwinding the belt 236 comprises a reel 278 that is positioned between the two strands 236.1 and 236.2 with an axis of rotation A278 parallel to the axis A268 of the receiver pulley 268. The reel 278 comprises at least one guide 280 for at least one of the strands 236.1 of the belt 236.

When the belt 236 is fully unwound, the strand 236.1 passes through the guide 280. When the reel 278 pivots about the axis A278, the guide 280 winds the strand 236.1 around the reel 278.

According to another variant, the reel 278 is not positioned between the strands but is positioned under the strand 236.2 that passes close to the reel 278. The reel 278 comprises a hook that is able to move in translation in a direction parallel to the axis of the reel 278, between a first position remote from the strand and a second position in which it hooks the strand 236.2. In the second position, the rotation of the reel 278 winds the strand 236.2 hooked by the hook around the reel 278.

According to another variant, the reel 278 is not positioned between the strands but is positioned under the strand 236.2 that passes close to the reel 278. The reel 278 comprises a fixed hook. According to this variant, when the user wishes to wind the belt 236, he or she manually positions the strand 236.2 under the hook such that the rotation of the reel 278 brings about the winding of the strand 236.2 hooked by the hook.

The movement of rotation of the reel 278 can be motorized or manual.

According to one embodiment, the ground station 238 comprises a crank 282 for the purpose of rotating the reel 278.

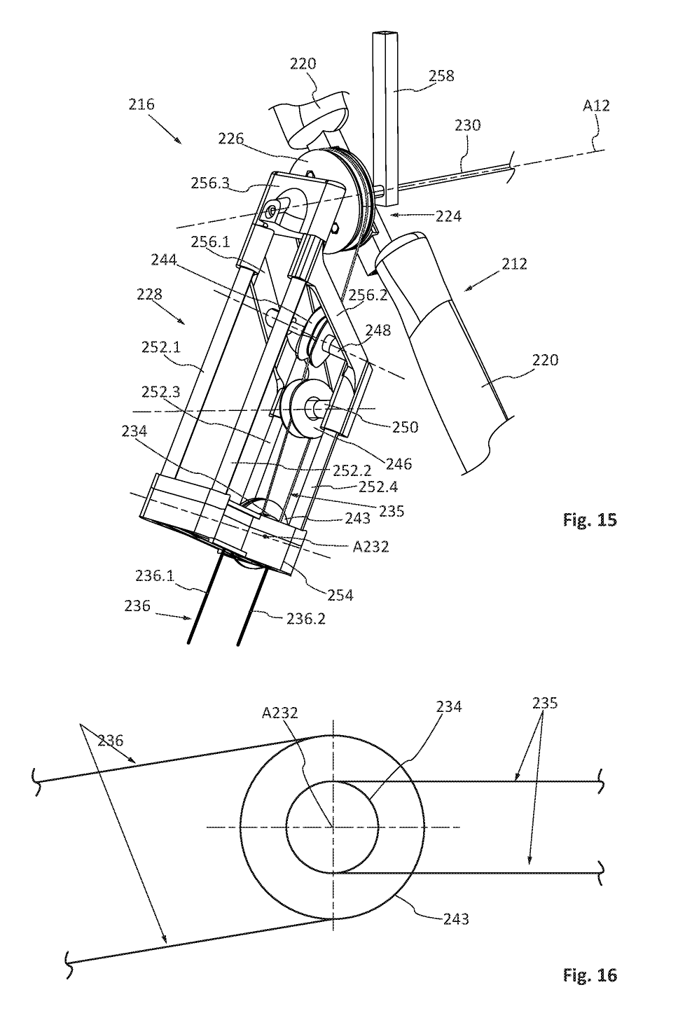

According to a third variant, shown in FIGS. 15 and 16, the airborne device comprises an airborne structure 216 that is close to the second variant, with those elements that are common to the second and third variants having the same reference sign.

According to this third variant, the system for transmitting the rotational movement of the wind turbine 212 to a ground station 238 comprises two belts 235 and 236.

The first belt 235 serves to transmit the rotational movement between a main pulley 226 that is driven in rotation by the wind turbine 212 and a first return-to-ground pulley 234. According to one embodiment, the first return pulley 234 is supported by a first pivoting shaft supported by the chassis 228, which defines a first pivot axis A232. The first return pulley 234 is arranged in a first guiding plane perpendicular to the first pivot axis A232. The first pivoting shaft is arranged on the chassis 228 at the opposite end from the main pulley 226.

According to one embodiment, the airborne structure comprises a third return pulley 244 and a fourth return pulley 246 between the first return pulley 234 and the main pulley 226 positioned on the chassis in the same manner as for the second variant.

The second belt 236 serves to transmit the rotational movement between a second return-to-ground pulley 243 and a ground station. This second return-to-ground pulley 243 is supported by the first pivoting shaft having the pivot axis A232 and connected to the first return-to-ground pulley 234. Thus, the rotation of the main pulley 226 drives, via the first belt 235, the rotation of the first return-to-ground pulley 234, which rotates the second return-to-ground pulley 243, with the second belt 236 transmitting the rotational movement of the second return-to-ground pulley 243 to the ground.

Providing two belts 235, 236 serves to reduce the stresses on the guiding systems (pulleys 226, 234, 244, 246) provided for the first belt 235, the tension in the first belt 235 being dissociated from the tension in the second belt 236, which is connected to the wind conditions.

Advantageously, the diameter of the second return-to-ground pulley 243 is greater than that of the first return-to-ground pulley 234, so as to obtain a gearing effect and better efficiency.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An airborne device comprising:
a wind turbine having an axis of rotation,
an airborne structure configured to support the wind turbine,
a lifting system configured to keep aloft the airborne structure, and
at least one belt to transmit a movement of rotation of the wind turbine to a ground station, said belt being guided by at least one return-to-ground pulley, each return-to-ground pulley being secured to a pivoting shaft, positioned in a guiding plane perpendicular to the pivoting shaft, and configured to guide the belt, and,
wherein the axis of rotation of the wind turbine and the guiding plane of each return-to-ground pulley form an angle of less than 60°.

2. The airborne device as claimed in claim 1, wherein the axis of rotation of the wind turbine is contained in the guiding plane of the at least one return-to-ground pulley.

3. The airborne device as claimed in claim 2, wherein the orientation of each pivoting shaft is essentially horizontal.

4. The airborne device as claimed in claim 1, wherein the belt comprises two strands that are tangential, at first and second points of tangency, to the at least one return-to-ground pulley, and wherein the airborne structure comprises, on a first side of the wind turbine, a first connection point for connection to the lifting system and, on a second side of the wind turbine, the first and second points of tangency, and in that a bisector, between a first straight line passing through the first connection point and the first point of tangency and a second straight line passing through the first connection point and the second point of tangency, forms an angle, with the axis of rotation of the wind turbine, essentially equal to a lifting angle with a tolerance range of +/−20°.

5. The airborne device as claimed in claim 4, wherein the airborne structure further comprises a fixed shaft on which pivots a pivoting support supporting blades of the wind turbine and a strut which has a first end connected to the fixed shaft, the first connection point being provided on the strut and remote from the fixed shaft.

6. The airborne device as claimed in wherein the airborne structure further comprises two return-to-ground pulleys, the first return-to-ground pulley having a point of tangency with the strand and the second return-to-ground pulley having a point of tangency with the strand.

7. The airborne device as claimed in claim 6, wherein the axis of rotation of the wind turbine forms with each guiding plane of the first and second return-to-ground pulleys an angle of less than 60°.

8. The airborne device as claimed in claim 7, wherein the axis of rotation of the wind turbine is perpendicular to the pivot axes of the first and second return-to-ground pulleys.

9. The airborne device as claimed in claim 4, wherein the airborne structure further comprises a stabilizing system for limiting the rotational movement about the axis of rotation of the wind turbine.

10. The airborne device as claimed in claim 9, the stabilizing system comprises an essentially rigid planar stabilizing surface which extends in a plane containing the axis of rotation of the wind turbine, which is connected to the fixed shaft and is parallel to the guiding planes of the first and second return-to-ground pulleys.

11. The airborne device as claimed in claim 1, wherein the ground station comprises a chassis that supports a receiver pulley which is configured to guide the belt, a generator coupled to the receiver pulley via a transmission system, and a system for winding and unwinding the belt.

12. The airborne device as claimed in claim 11, wherein the system for winding and unwinding the belt comprises a winding pulley that is positioned between the two strands of the belt with an axis of rotation parallel to the axis of the receiver pulley, the winding pulley comprising at least one guide for at least one of the strands of the belt.

13. The airborne device as claimed in claim 1, wherein the belt comprises a first strand positioned over the at least one return-to-ground pulley, and a second strand positioned under the at least one return-to-ground pulley, and wherein the airborne structure and the wind turbine are oriented and configured such that the direction of rotation of the at least one return-to-ground pulley tautens the first strand.

14. The airborne device as claimed in claim 1, wherein the airborne structure comprises a system for guiding the belt, which serves to take up slack in two strands of the belt.

15. The airborne device as claimed in claim 14, wherein the guiding system further comprises at least a first pair of rollers which are parallel to the axis of the pivoting shaft, have a small gap between them, and between which two strands of the belt pass.
